(19) United States
(12) Patent Application Publication
(10) Pub. No.: US 2026/0133574 A1
(43) Pub. Date: May 14, 2026

(54) SYSTEMS AND METHODS FOR EVALUATING REMAINING USEFUL LIFE PREDICTION ALGORITHMS

(71) Applicant: Schlumberger Technology Corporation, Sugar Land, TX (US)

(72) Inventors: Indranil Roychoudhury, Menlo Park, CA (US); Taoufik Wassar, Houston, TX (US); Prasham Sheth, Menlo Park, CA (US); Jose Celaya Galvan, Menlo Park, CA (US)

(21) Appl. No.: 18/946,435

(22) Filed: Nov. 13, 2024

(51) Int. Cl. G05B 23/02

(52) U.S. Cl. CPC G05B 23/0283

(57) ABSTRACT

Systems and methods for evaluating remaining useful life (RUL) prediction algorithms, for example, in the absence of run-to-failure ground truth data, are presented herein. For example, the systems and methods presented herein are configured to receive data relating to operation of equipment from one or more sensors associated with the equipment; predict an RUL of the equipment based at least in part on the received data; and evaluate an accuracy of the predicted RUL of the equipment during operation of the equipment.

### FIELD OF THE INVENTION

Aspects of the disclosure relate to systems and methods for evaluating remaining useful life (RUL) prediction algorithms, for example, in the absence of run-to-failure ground truth data.

### BACKGROUND INFORMATION

Remaining useful life (RUL) of equipment, such as production equipment, is often predicted using predictive maintenance algorithms to ascertain how long the equipment may be expected to be able to perform its rated functionality (e.g., production functionality) as part of a larger system (e.g., production system). In this disclosure, we focus on condition-based health management, where the RUL of a particular piece of equipment under consideration is predicted (and updated) periodically. This differs from reliability-based RUL prediction, where the RUL is predicted for an entire equipment population, and not the individual equipment under consideration.

In general, conventional predictive maintenance algorithms inherently include a certain degree of uncertainty due at least in part to ever-changing factors including, but not limited to, changes in the rated production functionality of the equipment itself over time, changes in the rated production functionality of other related equipment of the shared production system, changes to the makeup and layout of the other related equipment of the shared production system, changes in the rates of production of the production system, among other things. In addition, in many situations, the absence of certain important data (e.g., ground truth data) may further complicate the ability to accurately predict RUL. As such, the ability to more quickly and effectively ascertain how well the predictive maintenance algorithms are predicting the RUL of the equipment, taking into account such changes and missing data, is beneficial.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one non-limiting embodiment, a method includes receiving, via an analysis and control system, data relating to operation of equipment from one or more sensors associated with the equipment. The method also includes predicting, via the analysis and control system, a remaining useful life (RUL) of the equipment based at least in part on the received data. The method further includes evaluating, via the analysis and control system, an accuracy of the predicted RUL of the equipment during operation of the equipment.

In another non-limiting embodiment, an analysis and control system includes one or more processors configured to execute processor-executable instructions stored in memory of the analysis and control system. The processor-executable instructions, when executed by the one or more processors, cause the analysis and control system to receive data relating to operation of equipment from one or more sensors associated with the equipment, to predict an RUL of the equipment based at least in part on the received data, and to evaluate an accuracy of the predicted RUL of the equipment during operation of the equipment.

In yet another non-limiting embodiment, a non-transitory computer readable medium includes processor-executable instructions, which when executed by one or more processors of an analysis and control system, cause the analysis and control system to receive data relating to operation of equipment from one or more sensors associated with the equipment, to predict a remaining useful life (RUL) of the equipment based at least in part on the received data, and to evaluate an accuracy of the predicted RUL of the equipment during operation of the equipment.

### BRIEF DESCRIPTION OF THE DRAWINGS

Various aspects of this disclosure may be better understood upon reading the following detailed description and upon reference to the drawings, in which:

FIG. 1 illustrates an example system having a plurality of different pieces of equipment that may be utilized to accomplish the specific functions of the system, in accordance with embodiments of the present disclosure;

FIG. 2 illustrates an example oil and gas production system, in accordance with embodiments of the present disclosure;

FIG. 3 illustrates a production control system configured to control the oil and gas production system of FIG. 2, in accordance with embodiments of the present disclosure;

FIG. 4 illustrates a workflow for predicting RUL of equipment as well as evaluating the accuracy of the RUL prediction, in accordance with embodiments of the present disclosure;

FIG. 5 illustrates a graph of example results of a measurement-based PHM performance evaluation, in accordance with embodiments of the present disclosure;

FIG. 6 illustrates example weighting functions, in accordance with embodiments of the present disclosure;

FIG. 7 illustrates a graph of example results of an RUL-based PHM evaluation, in accordance with embodiments of the present disclosure;

FIG. 8 illustrates a graph of example results of how measured values at a plurality of time steps correlate to evaluation verdicts at the time steps, in accordance with embodiments of the present disclosure;

FIG. 9 illustrates an example of a graphical user interface used to provide a dashboard of relevant graphs and metrics relating to the outputs illustrated in FIGS. 5, 7, and 8, in accordance with embodiments of the present disclosure; and

FIG. 10 illustrates a flow diagram of a method for predicting RUL of equipment and evaluating the accuracy of the RUL prediction, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to describe certain embodiments more clearly.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the analysis and control system described herein may be configured to perform any and all of the data processing functions described herein automatically.

In addition, as used herein, the term “substantially similar” may be used to describe values that are different by only a relatively small degree relative to each other. For example, two values that are substantially similar may be values that are within 10% of each other, within 5% of each other, within 3% of each other, within 2% of each other, within 1% of each other, or even within a smaller threshold range, such as within 0.5% of each other or within 0.1% of each other.

As discussed above, it is relatively important to be able to accurately and effectively ascertain how well predictive maintenance algorithms are predicting the remaining useful life (RUL) of equipment, taking into account changes relating to the equipment and an overall system of which the equipment is part, as well as the fact that certain relatively important data may be missing. Doing so enables operators of the equipment to make more effective planning decisions including, but not limited to, deciding when to replace the equipment, when to make other changes relating to other equipment of the shared system, and so forth. To this end, the embodiments described herein provide an online methodology and associated metrics to more accurately and effectively evaluate the predictive performance of RUL prediction algorithms, for example, when ground truth or true RUL data is not available. The generated metrics may then be integrated into service-level indicators to be tracked, for example, via live online-enabled dashboards.

As described in greater detail herein, since ground truth failure data may not be available, certain sensor values may be assumed at particular times to be ground truth and be used to evaluate how well RUL prediction algorithms are currently predicting past measurement predictions up until the particular times (i.e., the current values of the sensors), and past RUL predictions up until the particular times (i.e., the time to reach the current values at multiple earlier times). In certain embodiments, the evaluation may give more weight to more recent predictions than to older predictions using different weighting schemes, and may generate service-level indicators for RUL prediction algorithm performance. As used herein, the term “ground truth data” is intended to refer to actual measurement data relating to equipment that is detected (e.g., using real-world sensors associated with the equipment) and may be used to train machine learning and/or artificial intelligence (AI) algorithms, as described in greater detail herein.

It should be noted that the RUL evaluation framework described herein is independent of the particular RUL prediction algorithms and can be applied to any and all prediction algorithms. In addition, as described above, an advantage of the RUL evaluation framework described herein lies in its ability to work without actual run-to-failure (ground truth) data, which is generally the most expensive to collect.

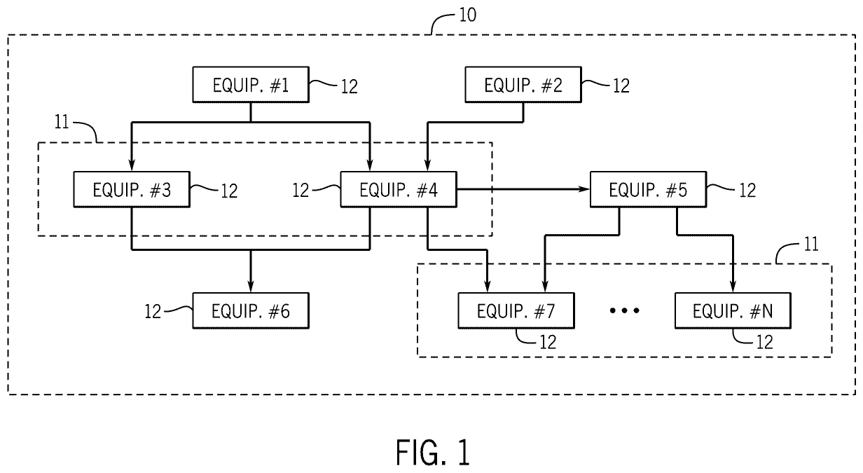

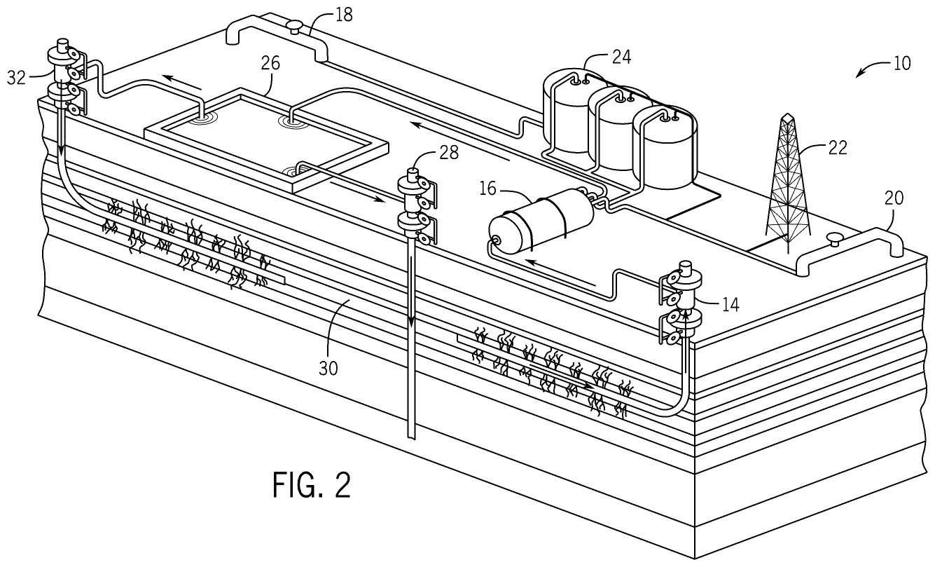

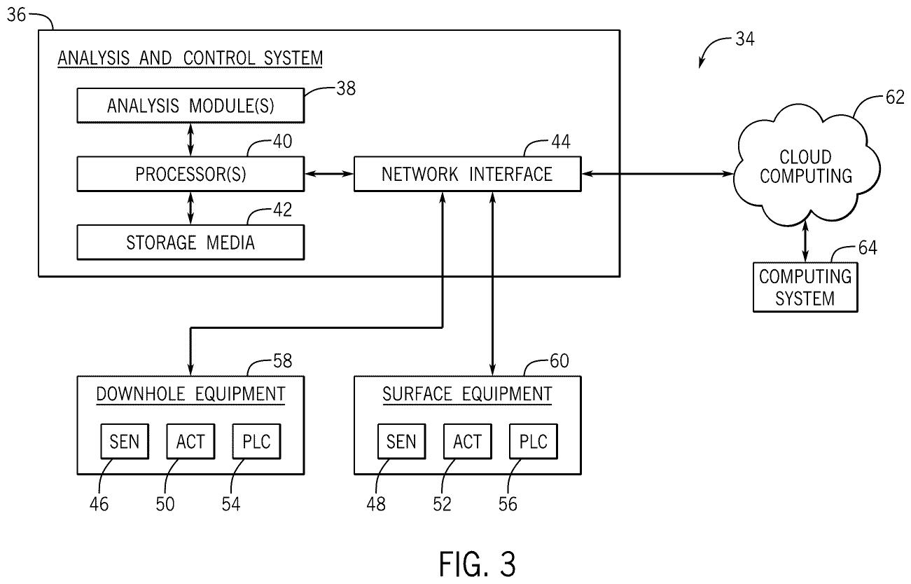

FIG. 1 illustrates an example system 10 having a plurality of different pieces of equipment 12 that may be utilized to accomplish the specific functions of the system 10. As illustrated, in certain embodiments, the system 10 may include various sub-systems 11 that are configured to perform certain functionalities that enable the overall functions of the system 10 as a whole. It will be appreciated that many of the types of equipment 12 that are described herein may, in certain embodiments, be production equipment 12 configured to accomplish production goals for a production system 10. For example, FIGS. 2 and 3 illustrate a specific example of an oil and gas production system 10 comprising various types of oilfield equipment 12. However, it should be noted that the techniques described herein may be extended to any conceivable type of system 10 that utilizes myriad equipment 12 to achieve objectives of the system 10. For example, the techniques described herein may be utilized in product manufacturing systems 10 utilizing various product manufacturing equipment 12, maintenance systems 10 utilizing various maintenance-related equipment 12, and so forth.

FIG. 2 illustrates an example oil and gas production system 10 having various worksite locations that contain equipment that may be monitored and controlled as described in greater detail herein. As illustrated in FIG. 2, oil and gas is produced along with water at one or more production wells 14. Then, each reservoir fluid (e.g., oil, gas, the produced water, the returned injected hydraulic fracturing fluid, and so forth) may be separated using one or more separators 16 with most of the produced oil and gas being directed into oil and gas pipelines 18, 20, respectively, and the remainder flared via a flare stack 22 and the produced water being directed to a temporary storage facility 24 for local treatment and subsequent storage in, for example, a surface pond 26. In certain embodiments, most of the produced water is re-injected into SWD wells 28 with only a small portion used for fracturing purposes via injection into a formation 30 by one or more fracturing wells 32. As described in greater detail herein, data relating to various pieces of production equipment 12 at each of the locations illustrated in FIG. 2 may be analyzed to determine RUL of the production equipment 12 using the techniques described herein. Furthermore, the analytic techniques described herein may be extended to other types of systems 10 other than oil and gas production systems 10.

FIG. 3 illustrates a control system 34 (e.g., that includes the analysis and control system 36) configured to control the oil and gas production system 10 of FIG. 2. In certain embodiments, the analysis and control system 36 may include one or more analysis modules 38 (e.g., a program of computer-executable instructions and associated data) that may be configured to perform various functions of the embodiments described herein. In certain embodiments, to perform these various functions, the one or more analysis modules 38 may execute on one or more processors 40 of the analysis and control system 36, which may be connected to one or more storage media 42 of the analysis and control system 36. Indeed, in certain embodiments, the one or more analysis modules 38 may be stored in the one or more storage media 42.

In certain embodiments, the computer-executable instructions of the one or more analysis modules 38, when executed by the one or more processors 40, may cause the one or more processors 40 to generate one or more models. Such models may be used by the analysis and control system 36 to predict the RUL of equipment 12 despite the fact that certain relatively important data, such as ground truth data and true RUL data, may not be available, as described in greater detail herein. In addition, the models may also be used to evaluate the accuracy of such RUL prediction for the equipment 12, as described in greater detail herein.

Over time, performance of the equipment 12 may change, for example, as the equipment 12 gets older. In addition, systems 10 of which the equipment 12 are a part may change, for example, when other equipment 12 is added or removed from the systems 10, when production (or other productivity) targets for the systems 10 change, and so forth. As such, the models used to evaluate the performance of the equipment 12 may need to adapt to such changes that occur over time. Therefore, the evaluation of the RUL prediction described herein may be based on the continually-adapted models. Indeed, the one or more analysis modules 38 may be configured to determine when the models of the equipment 12 need to be modified to enable more accurate RUL prediction, as described in greater detail herein. In certain embodiments, the models may be modified when prompted by an operator (e.g., interacting with graphical user interfaces, as described in greater detail herein). However, in other embodiments, the models may be automatically (e.g., without human intervention) modified by the one or more analysis modules 38 when the RUL prediction is evaluated to not be acceptable, as described in greater detail herein.

As such, the embodiments described herein enable the determination of RUL of equipment 12 (e.g., the equipment 58, 60 illustrated in FIG. 3, as well as the various equipment illustrated in FIG. 2) based on models that are adapted (e.g., automatically, in certain embodiments) when degradations of the models of the equipment 12 are detected (e.g., automatically, in certain embodiments). In certain embodiments, the models may be hybrid models (e.g., a combination of: (1) a physics-based definition of the equipment 12 and/or system 10 of which the equipment 12 is part and (2) data collected relating to the equipment 12 and/or system 10 of which the equipment 12 is part). The embodiments described herein may be extended to any applications requiring the use of RUL. Integrating the proposed techniques in such applications may help enhance the overall effectiveness of the applications.

In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning and/or artificial intelligence (AI) based processors, which may be used to train the models described herein to be capable of both predicting RUL of equipment 12 as well as evaluating the accuracy of such RUL prediction (and, in certain embodiments, adjusting models of the equipment 12 when the RUL prediction is evaluated as being unacceptable), as described in greater detail herein. In certain embodiments, the one or more storage media 42 may be implemented as one or more non-transitory computer-readable or machine-readable storage media. In certain embodiments, the one or more storage media 42 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) 38 may be provided on one computer-readable or machine-readable storage medium of the storage media 42, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 42 may be located either in the machine running the machine-readable instructions or may be located at a remote site from which machine-readable instructions may be downloaded over a network for execution.

In certain embodiments, the processor(s) 40 may be connected to a network interface 44 of the analysis and control system 36 to allow the analysis and control system 36 to communicate with multiple downhole sensors 46 and surface sensors 48, as well as communicate with actuators 50, 52 and/or programmable logic controllers (PLCs) 54, 56 of surface equipment 58 and of downhole equipment 60 (e.g., collectively referred to herein as production equipment 12) as described in greater detail herein. In certain embodiments, the network interface 44 may also facilitate the analysis and control system 36 to communicate data to cloud computing resources 62, which may in turn communicate with external computing systems 62 to access and/or to remotely interact with the analysis and control system 36.

It should be appreciated that the control system 34 illustrated in FIG. 3 is only one example of an analysis and control system, and that the control system 34 may have more or fewer components than shown, may combine additional components not depicted in the embodiment of FIG. 3, and/or the control system 34 may have a different configuration or arrangement of the components depicted in FIG. 3. In addition, the various components illustrated in FIG. 3 may be implemented in hardware, software, or a combination of both hardware and software, including one or more signal processing and/or application specific integrated circuits. Furthermore, the operations of the control system 34 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

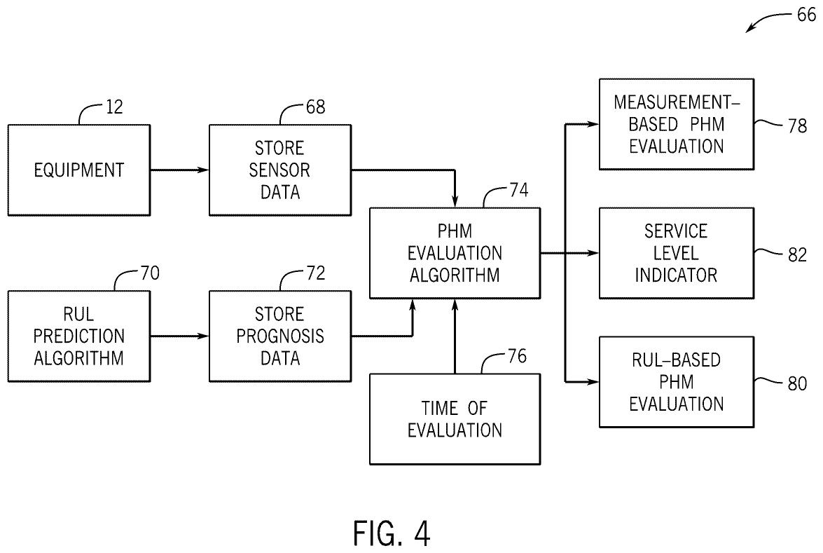

As described above, the embodiments described herein both enable the prediction of RUL of equipment 12 using predictive maintenance algorithms as well as ascertaining how well the predictive maintenance algorithms predict the RUL of the equipment 12 over time, for example, as changes occur with respect to the equipment 12 and/or a system 10 of which the equipment 12 is part. FIG. 4 illustrates a workflow 66 for predicting RUL of equipment 12 as well as evaluating the accuracy of the RUL prediction. For example, a particular piece of equipment 12 (e.g., production equipment 12 such as the equipment 58, 60 illustrated in FIG. 3, as well as the various equipment illustrated in FIG. 2) may have sensor data associated with operation of the equipment 12, which may be collected over time (e.g., by the sensors 46, 48 illustrated in FIG. 3) and, for example, stored in a database (e.g., block 68). As used herein, sensor data from X sensors (e.g., the sensors 46, 48, described with reference to FIG. 3) are named SN₁, SN₂, . . . , SN_{X} for sensors 1 through X, and are taken at different time steps T₁, T₂, . . . , T_{N} for time steps 1 through N. In addition, as used herein, the measured values are denoted as vals[SNAᵢ][Tⱼ] for sensor SNᵢ at time Tⱼ. In addition, in certain embodiments, an optional value of a health indicator threshold at each time Tⱼ, denoted as meas_threshold [Tⱼ], may also be stored.

In addition, an RUL prediction algorithm 70 may be used to generate prognosis data, which may also be stored in a database (e.g., block 72). For example, similar to the sensor data that is collected, the prognosis data may be generated at prediction time steps TP₁, TP₂, . . . , TP_{Q} for each sensor SNᵢ. The values estimated by the RUL prediction algorithm 70 at the various time steps are denoted as RUL prediction vals[SNᵢ][TPⱼ]. Other data that may be optionally stored include variances of these predictions (e.g., denoted by vars[SNᵢ][TPⱼ]). In addition, for each time step TPⱼ, the predicted RUL values (e.g., denoted by RULᵥₐₗ[TPⱼ]) may be stored. Also, in certain embodiments, variances of the predicted RUL values (e.g., denoted by RULᵥₐᵣ[TP]) and a health indicator value (e.g., denoted by health_indicator[Tⱼ]) may be optionally stored.

In addition, as described in greater detail herein, a predictive health monitoring (PHM) evaluation algorithm 74 may use the sensor data and the prognosis data (e.g., stored in blocks 68, 72) to generate at least three outputs at a particular time of evaluation 76, namely, measurement-based PHM evaluation results 78, RUL-based PHM evaluation results 80, and a service-level indicator 82 that summarizes the overall performance of the RUL prediction algorithm 70 (e.g., the accuracy of the prediction of RUL for the equipment 12). As described in greater detail herein, each of these outputs may be presented to an operator via a live, online-enabled dashboard displayed, for example, on a graphical user interface via computing system 64 (e.g., as illustrated in FIG. 3).

In general, a “look-back” evaluation window may first be defined, during which the performance of the RUL prediction algorithm 70 may be evaluated. The look-back evaluation window may include a set number of prediction data points (e.g., denoted as N_{lookback}) that were generated during a time window looking back from a current time of evaluation 76 (e.g., the time window being denoted as W_{lookback}). In general, W_{lookback} may be converted into N_{lookback} if the prediction is performed at fixed time intervals of T time units (e.g., that N_{lookback}=W_{lookback}/T). However, in certain embodiments, the time intervals may vary and, indeed, may be manually or automatically adjusted, as described in greater detail herein.

Using this approach, three such look-back windows may be defined: (1) a first look-back window for determining measurement-based PHM evaluation results 78 (e.g., denoted by W_{lookback_meas}), (2) a second look-back window for computing RUL-based PHM evaluation resultsv80 (e.g., denoted by W_{lookback_RUL}), and a third look-back window for computing the service level indicator (e.g., denoted by W_{lookback_SLI}). The usage of these three look-back windows will be described in greater detail below.

### Measurement-Based PHM Evaluation

For the measurement-based PHM evaluation 78, the current time may be denoted as t, and zₜ(t) may denote the true value of sensor z made at time t. At each time step t, look-backs at t_{meas_eval}∈N_{lookback_meas} predictions may be made. Now, if zₜ{_{meas_eval})≤±error_bound_meas, then zₜ{t_{meas_eval})∈{acceptable_points}, else, zₜ{_{meas_eval})∈ {unacceptable_points}. In other words, for each time step t where true values of a particular sensor z are within a measurement error bounding value (e.g., error_bound_meas), the data points may be considered acceptable. Otherwise, the data points may be considered unacceptable. Then, eval_verdict_meas may be computed using a weighting function based on the acceptable_points and the unacceptable_points. For example, an example weighting function may be eval_verdict_meas=weighting_function({acceptable_points} U {unacceptable_points}).

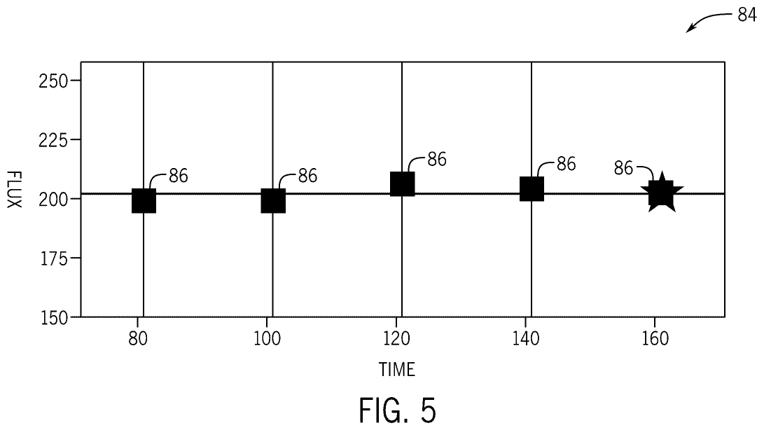

FIG. 5 illustrates a graph 84 of example results of the measurement-based PHM performance evaluation 66 (e.g., using the PHM evaluation algorithm 74). In the illustrated example, the flux (e.g., flow rate) associated with a particular piece of equipment 12 at five time steps t (e.g., 80 days, 100 days, 120 days, 140 days, and 160 days) relative to a time of evaluation (e.g., 160 days) are considered. As illustrated, the prediction of the flux at each of the look-back prediction data points are evaluated as being acceptable (e.g., within error_bound_meas). Therefore, in the illustrated example, eval_verdict_meas would be equal to 1.0 insofar as all of the data points are considered acceptable_points (as indicated by element number 86 in FIG. 5). However, if any of the data points had been considered unacceptable_points, then eval_verdict_meas would be less than 1.0 based on which particular weighting function is used.

There are many various types of weighting functions that may be implemented. For example, some example weighing functions may include, but are not limited to: (1) unweighted mean (e.g., where a simple majority of acceptable_points versus unacceptable_points is determined), (2) custom weighted average, (3) nonlinearly increasing weights, (4) linearly increasing weights, and (5) exponentially increasing weights. The goal of having different weighting schemes is to give more weight to nearer predictions (e.g., time steps immediately before the time of evaluation) than predictions made farther back in time. In general, if eval_verdict>=0.5, then the performance is deemed to be acceptable so far. Otherwise, the performance is deemed to be unacceptable.

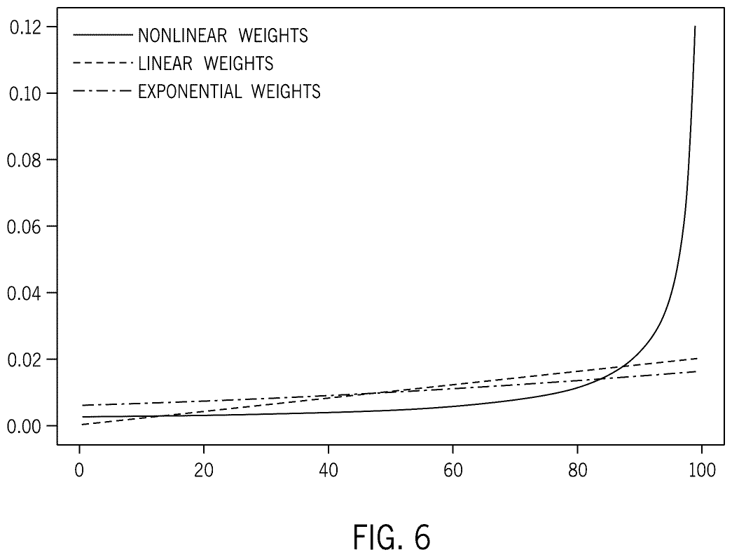

Table 1 illustrates example details of how the various weighting functions may be used to determine eval_verdict. wᵢ denotes a weighting value at a particular look-back time point i. t^{eval}, t^{start}, and t^{end} denote time of evaluation, start time of the look-back window, and end time of the look-back window, respectively. FIG. 6 illustrates example weighting functions. In particular, FIG. 6 illustrates weighting values at various data points for nonlinearly increasing weights, linearly increasing weights, and exponentially increasing weights where the time of evaluation is t=100 days and the look-back window is t=0 days through t=100 days. As illustrated, each weighting function weighs data points nearer to the time of evaluation more than data points further back in time from the time of evaluation. However, the degree to which the weighting functions increase as they are closer to the time evaluation varies.

TABLE 1
Various weighting functions that may be used to determine eval_verdict.

| | |
|---|---|
| Unweighted mean | $eval\_verdict = \frac{\sum acceptable\_points}{\sum acceptable\_points + \sum unacceptable\_points}$ |
| Custom weighted average | $eval\_verdict = \frac{\sum {w}_{i} x acceptable\_points}{\sum {w}_{i}}$ |
| Nonlinearly increasing weights | ${w}_{i} = \frac{1}{{t}^{current} - {t}_{i}^{eval} + 1 {e}^{- 8}}$ |
| | $eval\_verdict = \frac{\sum {w}_{i} x acceptable\_points}{\sum {w}_{i}}$ |
| Linearly increasing weights | ${w}_{i} = \frac{{t}_{i}^{eval}}{{t}^{end} - {t}^{start}}$ |
| | $eval\_verdict = \frac{\sum {w}_{i} x acceptable\_points}{\sum {w}_{i}}$ |
| Exponentially increasing weights | ${w}_{i} = \frac{{t}^{eval}}{{t}^{end} - {t}^{start}}$ |
| | $eval\_verdict = \frac{\sum {w}_{i} x acceptable\_points}{\sum {w}_{i}}$ |

### RUL-Based PHM Evaluation

The RUL-based evaluation scheme evaluates how well the RUL prediction algorithm 70 predicted the RUL at different times in the past. Since ground truth RUL data is not present, the threshold may be assumed to be the current value of a sensor and a determination may be made as to how well the RUL prediction algorithm 70 predicted an amount of time that was required at that point in time in the past to reach the current sensor reading value.

If the current time is t and θₑᵥₐₗ=threshold_function(zₜ(t)) is the evaluation threshold computed by a threshold function using sensors (e.g., the sensors 46, 48, described with reference to FIG. 3) and state variables at time t. Then, RULₜᵣᵤₑ may be set to t. For each t_{meas_eval}∈prog_data [‘times’][−N_{lookback_RUL}):−1], the stored threshold values predicted at time t_{meas_eval} may be evaluated by the PHM algorithm. These may be either stored beforehand or computer based on {z(t_{meas_eval}), z(t_{meas_eval}+1), . . . , z(RUL(t_{meas_eval})}. Then, RULₜ(t_{meas_eval}) may be found and, if RULₜ(t_{meas_eval})≤±error_bound_RUL, then RULₜ(t_{meas_eval})∈{acceptable_points}; otherwise, RULₜ(t_{meas_eval}) ∈{unacceptable_points}. Finally, eval_verdict_RUL may be computed as weighting_function({acceptable_points} U {unacceptable_points}). As above with respect to the measurement-based PHM evaluation 78, in general, if eval_verdict_RUL>=0.5, then the performance is deemed to be acceptable so far. Otherwise, the performance is deemed to be unacceptable.

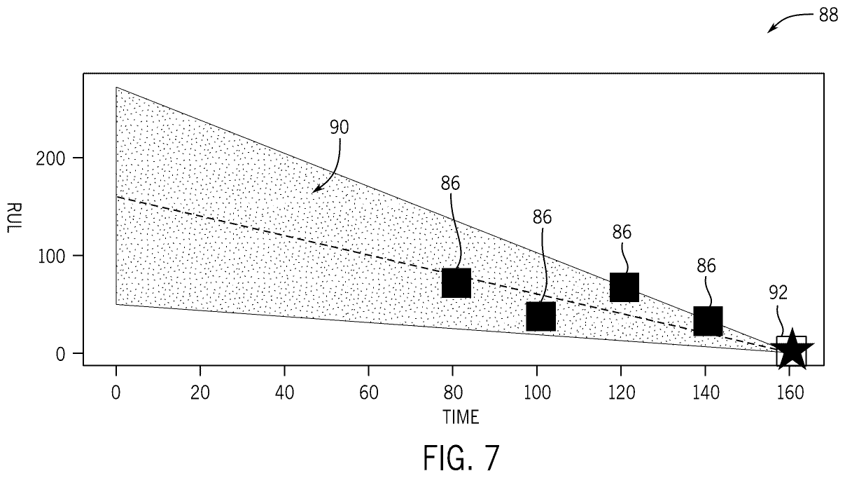

FIG. 7 illustrates a graph 88 of example results of the RUL-based PHM evaluation 80 (e.g., using the RUL prediction algorithm 70). In the illustrated example, the RUL of a particular piece of equipment 12 at five time steps t (e.g., 80 days, 100 days, 120 days, 140 days, and 160 days) relative to a time of evaluation (e.g., 160 days) are considered. As illustrated, the RUL at each of the look-back prediction data points prior to at the time of evaluation are determined to be acceptable (e.g., within error_bound_RUL, illustrated by area 90). Therefore, in the illustrated example, eval_verdict_RUL would be equal to relatively close to 1.0 insofar as the previous four data points are acceptable_points (as indicated by element number 86 in FIG. 7), whereas the most recent data point is the only unacceptable_point (as indicated by element number 92 in FIG. 7).

### Computing a Service-Level Indicator for the PHM Algorithms

Finally, a service level indicator (SLI) 82 for the overall performance of the RUL prediction algorithm may be determined by applying the same weighting schemes described above to either the measurement-based PHM evaluation labels or the RUL-based PHM evaluation labels, as described above. First, the SLI lookback window W_{lookback_SLI} may be determined. Then, the SLI 82 may be generated based on whether the measurement-based PHM evaluation labels or the RUL-based PHM evaluation labels are being used as the computing criteria. For example, if the RUL-based PHM evaluation labels are being used as the computing criteria, then eval_verdict_SLI may be set equal to weighting_function({eval_verdict_meas}). Otherwise, if the measurement-based PHM evaluation labels are being used as the computing criteria, then eval_verdict_SLI may be set equal to weighting_function({eval_verdict_RUL}).

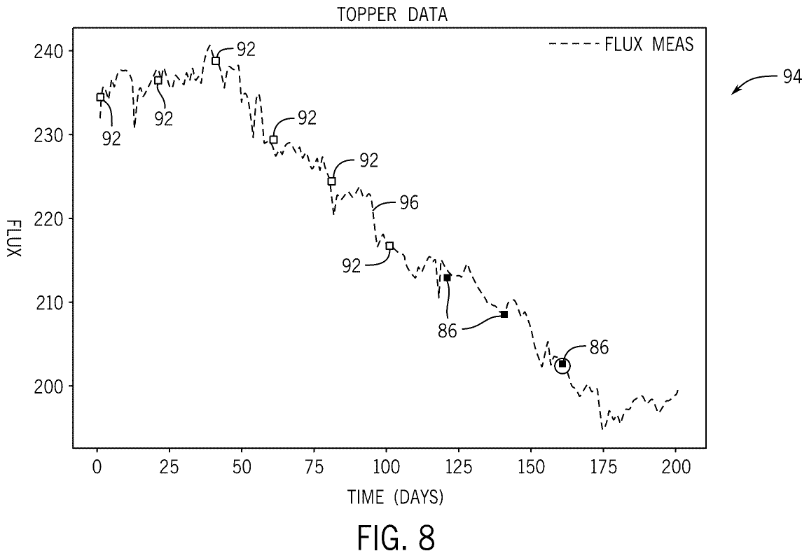

FIG. 8 illustrates a graph 94 of example results of how measured values 96 of flux at a plurality of time steps t correlate to either eval_verdict or eval_verdict_RUL, depending on whether the measurement-based PHM performance evaluation 66 (e.g., using the PHM evaluation algorithm 74) or the RUL-based PHM evaluation 80 (e.g., using the RUL prediction algorithm 70) are used to determine the accuracy of the predictions. In the illustrated example, nine time steps t (e.g., 0 days, 20 days, 40 days, 60 days, 80 days, 100 days, 120 days, 140 days, and 160 days) relative to a time of evaluation (e.g., 160 days) are considered. As illustrated, only the three most recent of the nine total time steps t are considered as acceptable_points (as indicated by element number 86 in FIG. 8). The SLI 82 may be determined based on these three acceptable_points and the six other unacceptable_points (as indicated by element number 92 in FIG. 8) depending on which type of weighting function is used.

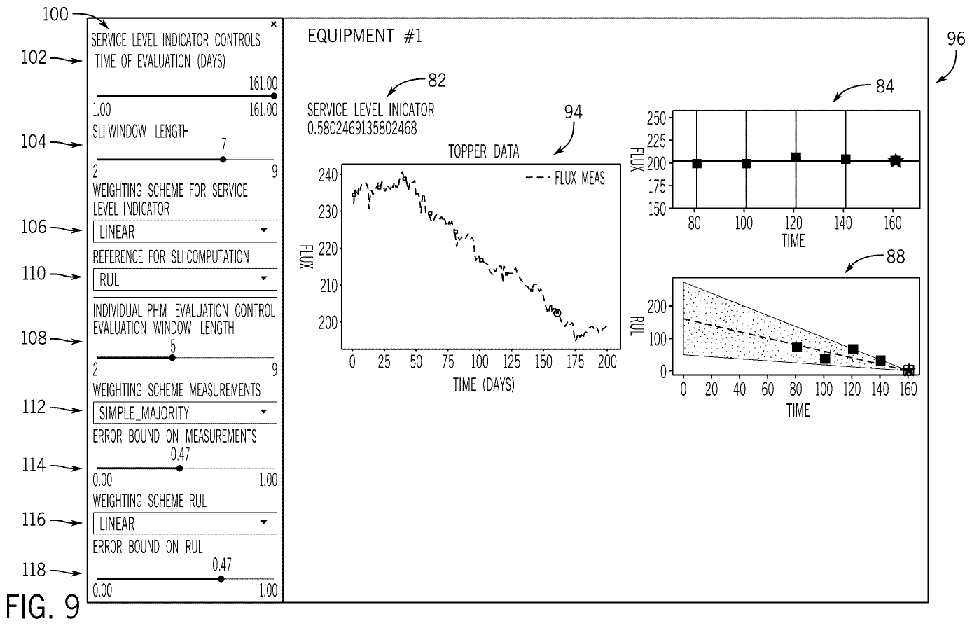

FIG. 9 illustrates an example of a graphical user interface (GUI) 96 used to provide the dashboard of relevant graphs and metrics relating to the outputs illustrated in FIGS. 5, 7, and 8. The GUI 96 may be provided to a computing system 64 used by an operator by the analysis and control system 36 illustrated in FIG. 3. The GUI 96 may present various graphs and metrics related to the RUL prediction algorithms and systems described herein, which are determined based on the sensor data 68 and prognosis data 72 that are stored in one or more databases, as described with reference to FIG. 4.

For example, as illustrated in FIG. 9, in certain embodiments, the GUI 96 may present the graph 84 of example results of the measurement-based PHM performance evaluation 66 (e.g., using the PHM evaluation algorithm 74) described with reference to FIG. 5, the graph 88 of example results of the RUL-based PHM evaluation 80 (e.g., using the RUL prediction algorithm 70) described with reference to FIG. 7, the graph 94 of example results of how measured values of flux at a plurality of time steps t correlate to either eval_verdict or eval_verdict_RUL, depending on whether the measurement-based PHM performance evaluation 66 (e.g., using the PHM evaluation algorithm 74) or the RUL-based PHM evaluation 80 (e.g., using the RUL prediction algorithm 70) are used to determine the accuracy of the predictions, and the SLI 82 that is calculated.

In addition, the GUI 96 may include an options pane 100 within which an operator may make select certain options for the analysis of the RUL prediction described herein. As illustrated, the options displayed in the options pane 100 may include a Time of Evaluation slider 102 that is used to select the particular time of evaluation from which the look-back windows are determined. In addition, the options displayed in the options pane 100 may include an SLI Window Length slider 104 that defines the number of data points that may be used from the time of evaluation as the look-back window for evaluation of the SLI 82. In addition, the options displayed in the options pane 100 may include a Weighting Scheme for SLI drop-down box 106 used to select an SLI weighting scheme used to determine the SLI 82, the weighting schemes being described in greater detail above.

It is noted that the SLI window length (e.g., selected via the SLI Window Length slider 104) that defines the number of data points that may be used from the time of evaluation as the look-back window for evaluation of the SLI 82 may be different than a an evaluation window length (e.g., which may be selected via an Evaluation Window Length slider 108) that defines the number of data points that may be used from the time of evaluation as the look-back window for evaluation of the RUL based on whether the RUL prediction algorithm 70 or the PHM evaluation algorithm 74 are selected, for example, via an SLI Computation Reference drop-down box 110.

As illustrated in FIG. 9, the options displayed in the options pane 100 may also include a Weighting Scheme Measurements drop-down box 112 and an Error Bound on Measurements slider 114 to enable an operator to select a weighting scheme to be used for the measurements of the evaluation (e.g., the weighting schemes described in greater detail above) and an error bound on the measurements, respectively, if the PHM evaluation algorithm 74 is used (e.g., when selected via the SLI Computation Reference drop-down box 110). In addition, the options displayed in the options pane 100 may also include a Weighting Scheme RUL drop-down box 116 and an Error Bound on RUL slider 118 to enable an operator to select a weighting scheme to be used for RUL of the evaluation (e.g., the weighting schemes described in greater detail above) and an error bound on RUL, respectively, if the RUL prediction algorithm 70 is used (e.g., when selected via the SLI Computation Reference drop-down box 110). In certain embodiments, the Weighting Scheme Measurements drop-down box 112, Error Bound on Measurements slider 114, Weighting Scheme RUL drop-down box 116, and Error Bound on RUL slider 118 may only be selectable when the associated evaluation scheme is selected via the SLI Computation Reference drop-down box 110.

In addition, in certain embodiments, the GUI 96 may be configured to accept inputs from an operator when the RUL prediction is determined by the operator to not be acceptable, wherein the inputs may cause the analysis and control system 36 to adapt models of the equipment 12 being evaluated as the RUL prediction for the equipment 12 changes over time, becoming unacceptable. As such, the models may be modified to, for example, take into account changes that occur relating to the equipment 12 over time. In other embodiments, the analysis and control system 36 may automatically (e.g., without human intervention) adapt the models of the equipment 12, for example, when the analysis and control system 36 automatically (e.g., without human intervention) determines that the models are no longer capable of accurately predicting RUL of the equipment 12.

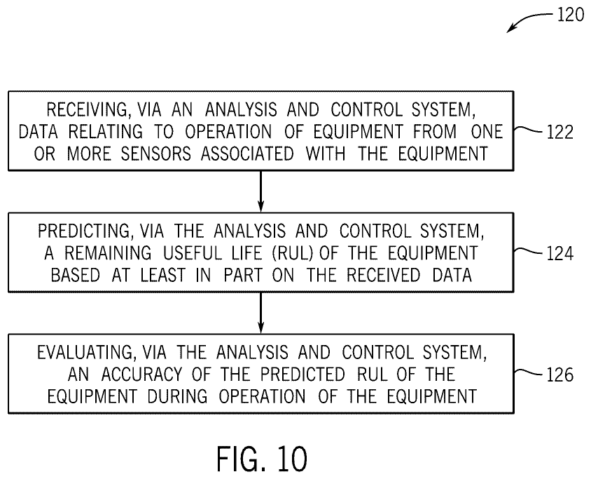

FIG. 10 illustrates a flow diagram of a method 120 for predicting RUL of equipment 12 (e.g., the various equipment 58, 60 illustrated in FIG. 3) and evaluating the accuracy of the RUL prediction. In certain embodiments, the method 120 may include receiving, via the analysis and control system 36, data relating to operation of equipment 12 from one or more sensors (e.g., the sensors 46, 48 illustrated in FIG. 3) associated with the equipment 12 (block 122). In addition, in certain embodiments, the method 120 may include predicting, via the analysis and control system 36, an RUL of the equipment 12 based at least in part on the received data (block 124). In addition, in certain embodiments, the method 120 may include evaluating, via the analysis and control system 36, an accuracy of the predicted RUL of the equipment 12 during operation of the equipment 12 (block 126). As such, the embodiments described herein enable not only the prediction of an RUL of equipment 12, but also the evaluation of the accuracy of such RUL prediction, during operation of the equipment 12 in an iterative manner to, for example, enable operators of the equipment 12 to make decisions to enhance the RUL for the equipment 12 and/or to adjust operations of a system 10 of which the equipment 12 is a part.

In addition, in certain embodiments, the method 120 may include evaluating, via the analysis and control system 36, the accuracy of the predicted RUL of the equipment 12 using measurement-based PHM evaluation algorithms 78. Alternatively, or in addition to, in certain embodiments, the method 120 may include evaluating, via the analysis and control system 36, the accuracy of the predicted RUL of the equipment 12 using RUL-based PHM evaluation algorithms 80. Regardless of the particular PHM algorithms 78, 80 used, in certain embodiments, the method 120 may include evaluating, via the analysis and control system 36, the accuracy of the predicted RUL of the equipment 12 by analyzing data points in a look-back window measured from a time of evaluation 76. In addition, in certain embodiments, the method 120 may include evaluating, via the analysis and control system 36, the accuracy of the predicted RUL of the equipment 12 by applying a weighting scheme (e.g., the various weighting schemes described with reference to Table 1) to the data points in the look-back window measured from the time of evaluation 76. For example, in certain embodiments, the weighting scheme is selected by an operator of the equipment 12.

In addition, in certain embodiments, the method 120 may include predicting, via the analysis and control system 36, the RUL of the equipment 12 based at least in part on a model of the equipment 12. In addition, in certain embodiments, the method 120 may include calculating, via the analysis and control system 36, an SLI 82 relating to the accuracy of the predicted RUL of the equipment 12; and adjusting, via the analysis and control system 36, the model of the equipment 12 in response to determining that the SLI 82 is below a predetermined threshold (e.g., below 0.5, in certain embodiments). In addition, in certain embodiments, the method 120 may include automatically (e.g., without human intervention) controlling, via the analysis and control system 36, one or more operational parameters of the equipment 12 based at least in part on the predicted RUL of the equipment 12. As such, the analysis and control system 36 may be capable of making adjustments to the performance of the equipment 12 to enhance the RUL of the equipment 12 during operation of the equipment 12.

As described herein, the disclosed techniques are capable of evaluating RUL prediction algorithms in the absence of ground-truth failure data. The embodiments described herein have been validated for several different types of equipment 12 including, but not limited to acid gas separation membranes, power unit bushings, coalescer filter, and hot oil heaters. However, it is believed that the embodiments described herein may be extended to the analysis of any types of equipment 12 and related systems 10.

The embodiments described herein enable the presentation of RUL-related metrics, which can demonstrate the accuracy of RUL prediction that is not heretofore available. By providing concrete evidence that long-term RUL predictions for equipment 12 are scientifically valid, consistent, and valuable, operators of the equipment 12 can be more confident about business decisions that are made based on such RUL predictions, thereby optimizing their operations and reducing maintenance costs through asset utilization, increased efficiency, and reduced downtime.

All presently known metrics for evaluating the performance of RUL prediction algorithms rely on ground truth RUL (e.g., that are determined after actual failures) to help operators validate the performance of the algorithms. Therefore, these known techniques require such ground truth RUL data to be available. The embodiments described herein can be implemented without the availability of such ground truth RUL information (e.g., during the life of the equipment 12), thereby enabling operators to assess the quality of the RUL prediction algorithms at any time during operation of the equipment 12.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
receiving, via an analysis and control system, data relating to operation of equipment from one or more sensors associated with the equipment;
predicting, via the analysis and control system, a remaining useful life (RUL) of the equipment based at least in part on the received data; and
evaluating, via the analysis and control system, an accuracy of the predicted RUL of the equipment during operation of the equipment.

2. The method of claim 1, comprising evaluating, via the analysis and control system, the accuracy of the predicted RUL of the equipment using measurement-based predictive health monitoring (PHM) evaluation algorithms.

3. The method of claim 2, comprising evaluating, via the analysis and control system, the accuracy of the predicted RUL of the equipment by analyzing data points in a look-back window measured from a time of evaluation.

4. The method of claim 3, comprising evaluating, via the analysis and control system, the accuracy of the predicted RUL of the equipment by applying a weighting scheme to the data points in the look-back window measured from the time of evaluation, wherein the weighting scheme is selected by an operator of the equipment.

5. The method of claim 1, comprising evaluating, via the analysis and control system, the accuracy of the predicted RUL of the equipment using RUL-based predictive health monitoring (PHM) evaluation algorithms.

6. The method of claim 5, comprising evaluating, via the analysis and control system, the accuracy of the predicted RUL of the equipment by analyzing data points in a look-back window measured from a time of evaluation.

7. The method of claim 6, comprising evaluating, via the analysis and control system, the accuracy of the predicted RUL of the equipment by applying a weighting scheme to the data points in the look-back window measured from the time of evaluation, wherein the weighting scheme is selected by an operator of the equipment.

8. The method of claim 1, comprising predicting, via the analysis and control system, the RUL of the equipment based at least in part on a model of the equipment.

9. The method of claim 8, comprising:
calculating, via the analysis and control system, a service level indicator relating to the accuracy of the predicted RUL of the equipment; and
adjusting, via the analysis and control system, the model of the equipment in response to determining that the service level indicator is below a predetermined threshold.

10. The method of claim 1, comprising automatically controlling, via the analysis and control system, one or more operational parameters of the equipment based at least in part on the predicted RUL of the equipment.

11. An analysis and control system, comprising:
one or more processors configured to execute processor-executable instructions stored in memory of the analysis and control system, wherein the processor-executable instructions, when executed by the one or more processors, cause the analysis and control system to:
receive data relating to operation of equipment from one or more sensors associated with the equipment;
predict a remaining useful life (RUL) of the equipment based at least in part on the received data; and
evaluate an accuracy of the predicted RUL of the equipment during operation of the equipment.

12. The analysis and control system of claim 11, wherein the processor-executable instructions, when executed by the one or more processors, cause the analysis and control system to evaluate the accuracy of the predicted RUL of the equipment using measurement-based predictive health monitoring (PHM) evaluation algorithms.

13. The analysis and control system of claim 12, wherein the processor-executable instructions, when executed by the one or more processors, cause the analysis and control system to evaluate the accuracy of the predicted RUL of the equipment by analyzing data points in a look-back window measured from a time of evaluation.

14. The analysis and control system of claim 13, wherein the processor-executable instructions, when executed by the one or more processors, cause the analysis and control system to evaluate the accuracy of the predicted RUL of the equipment by applying a weighting scheme to the data points in the look-back window measured from the time of evaluation, wherein the weighting scheme is selected by an operator of the equipment.

15. The analysis and control system of claim 11, wherein the processor-executable instructions, when executed by the one or more processors, cause the analysis and control system to evaluate the accuracy of the predicted RUL of the equipment using RUL-based predictive health monitoring (PHM) evaluation algorithms.

16. The analysis and control system of claim 15, wherein the processor-executable instructions, when executed by the one or more processors, cause the analysis and control system to evaluate the accuracy of the predicted RUL of the equipment by analyzing data points in a look-back window measured from a time of evaluation.

17. The analysis and control system of claim 16, wherein the processor-executable instructions, when executed by the one or more processors, cause the analysis and control system to evaluate the accuracy of the predicted RUL of the equipment by applying a weighting scheme to the data points in the look-back window measured from the time of evaluation, wherein the weighting scheme is selected by an operator of the equipment.

18. The analysis and control system of claim 11, wherein the processor-executable instructions, when executed by the one or more processors, cause the analysis and control system to predict the RUL of the equipment based at least in part on a model of the equipment.

19. The analysis and control system of claim 18, wherein the processor-executable instructions, when executed by the one or more processors, cause the analysis and control system to:
calculate a service level indicator relating to the accuracy of the predicted RUL of the equipment; and
adjust the model of the equipment in response to determining that the service level indicator is below a predetermined threshold.

20. A non-transitory computer readable medium, comprising:
processor-executable instructions, which when executed by one or more processors of an analysis and control system, cause the analysis and control system to:
receive data relating to operation of equipment from one or more sensors associated with the equipment;
predict a remaining useful life (RUL) of the equipment based at least in part on the received data; and
evaluate an accuracy of the predicted RUL of the equipment during operation of the equipment.
